(19) United States
(12) Patent Application Publication
(10) Pub. No.: US 2008/0121031 A1
(43) Pub. Date: May 29, 2008

(54) Pressure sensing apparatus for tire

(75) Inventor: Shiao-Hwa Huang, Taichung City (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/604,863

(22) Filed: Nov. 28, 2006

(51) Int. Cl. B60C 23/02

(52) U.S. Cl. 73/146.4

(57) ABSTRACT

A pressure sensing apparatus includes a pressure sensor for detecting tire pressure and generating a signal corresponding to the tire pressure, and an electrically conducting air valve seat connected to the pressure sensor for signal transmission therethrough to a transmitting antenna. The antenna has a metal cap connected to the air valve seat, at least one annual substrate defining a center coupling hole into which the cap is inserted, and at least one metal conducting wire spirally mounted in the at least one substrate around the center coupling hole. The metal conducting wire has an inner end exposed to a periphery wall of the center coupling hole of the substrate and electrically connected to the cap.

### BACKGROUND OF THE INVENTION

1. Field of the Invention

The present invention relates to a unit of Tire Pressure Monitoring System (TPMS) and more specifically, to a tire pressure sensing apparatus installed in the tire of a vehicle for sensing the pressure of the tire and transmitting the pressure signal wirelessly.

2. Description of the Related Art

A typical wireless tire pressure sensing apparatus comprises a transmitter circuit coupled to each of a plurality of tires on a vehicle. The transmitter circuit is generally provided with a transmitting antenna and a pressure sensor. The pressure sensor detects the pressure of the tire and produces a corresponding pressure signal. The pressure signal is modulated into a radio frequency signal, and then transmitted to a main unit of the TPMS in the car wirelessly by the transmitting antenna. The main unit demodulates the radio frequency signal and converts the signal into a corresponding tire pressure value readable on a display panel so that the driver can monitor the tire pressure to prevent a potential accident when driving the car. However, because a tire has a metal structure, i.e. tire rim, around the periphery thereof, the metal structure provides a shielding effect that may interfere with the transmission of the radio frequency signal to be transmitted by the pressure sensing apparatus in the tire.

In order to eliminate the aforesaid problem, a rod-like air valve is created for use as a transmitting antenna. Because a part of the rod-like air valve extends out of the tire after installation of the pressure sensing apparatus, the metal structure of the tire does not interfere with the transmission of the radio frequency signal produced by the pressure sensing apparatus. However, the transmitting range of the rod-like air valve is limited, and the main unit in the car can receive the radio frequency signal transmitted by the rod-like air valve only at a particular angle. Therefore, this design of pressure sensing apparatus is still not satisfactory in function.

### SUMMARY OF THE INVENTION

The present invention has been accomplished under the circumstances in view. It is one objective of the present invention to provide a pressure sensing apparatus of which the signal transmission has a wide-angle characteristic.

To achieve this objective of the present invention, the pressure sensing apparatus comprises a pressure sensor for detecting tire pressure and generating a signal corresponding to the tire pressure, an air valve seat made of an electrically conducting material, electrically connected to the pressure sensor and provided with an air passage extending through two distal ends thereof, and a transmitting antenna having a cap made of a metal material and connected to the air valve seat, at least one substrate having an annular shape defining a center coupling hole coupled to the cap, and at least one metal conducting wire spirally mounted in the at least one substrate around the center coupling hole. The metal conducting wire has an inner end exposed to a periphery wall of the center coupling hole of the substrate and electrically connected to the cap.

In a preferred embodiment of the present invention, the cap is fastened to one end of the air valve seat and provided with a center air hole in air communication with the air passage. A plunger is inserted through the center air hole of the cap and movable relative to the cap between a first position and a second position. A valve stem is mounted in the air passage and movable with the plunger between the first position where the valve stem blocks the air passage and the second position where the valve stem opens the air passage.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of a pressure sensing apparatus according to a preferred embodiment of the present invention;

FIG. 2 is schematic drawing showing that the pressure sensing apparatus in accordance with the preferred embodiment of the present invention is installed in a tire;

FIG. 3 is an exploded view in an enlarged scale of a part of the pressure sensing apparatus according to the preferred embodiment of the present invention, showing the structure of the transmitting antenna;

FIG. 4 is a sectional view of the preferred embodiment of the present invention, showing that the air passage of the air valve seat of the pressure sensing apparatus is blocked;

FIG. 5 is similar to FIG. 4 but showing that the air passage is opened;

FIG. 6 is a sectional view of an alternate form of the pressure sensing apparatus according to the present invention, and

FIG. 7 is a perspective view of another alternate form of the pressure sensing apparatus according to the present invention.

### DETAILED DESCRIPTION OF THE INVENTION

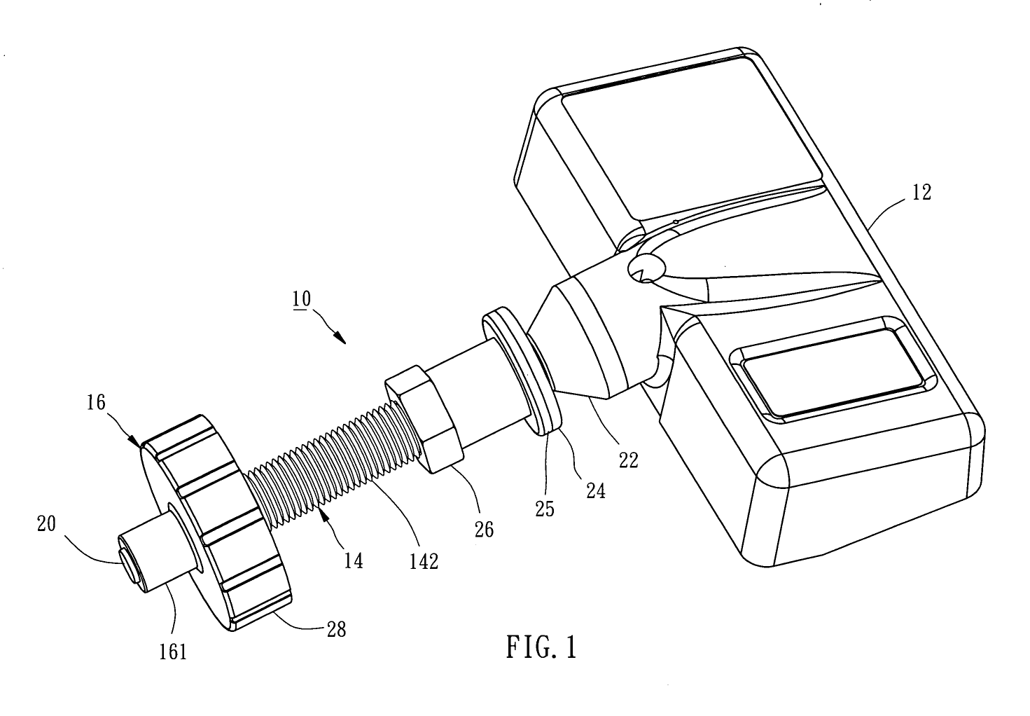

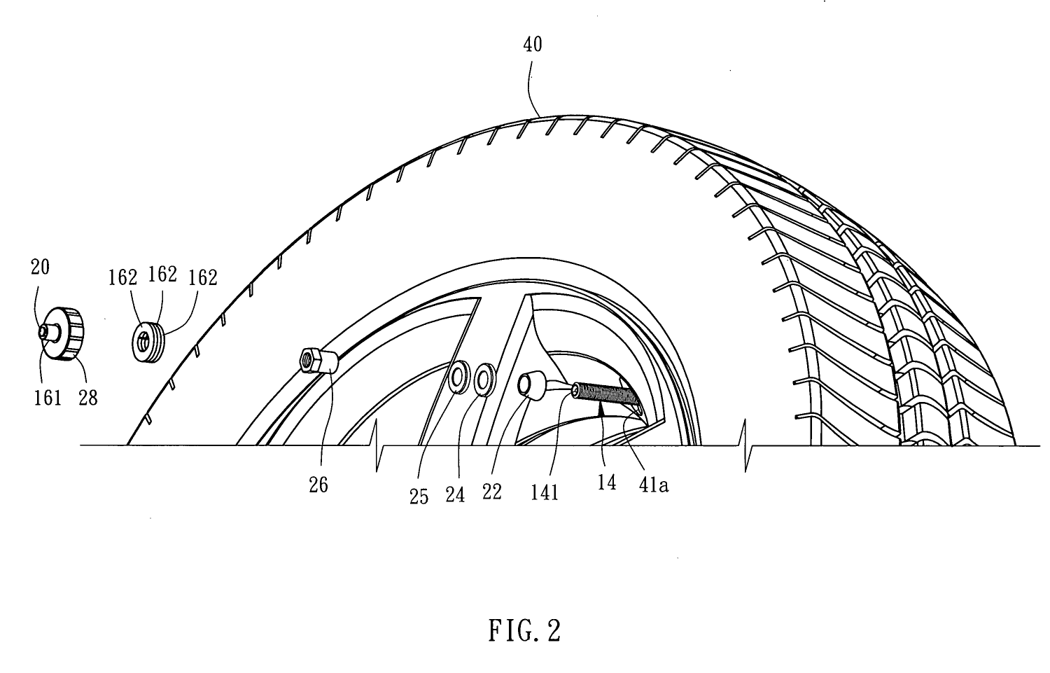

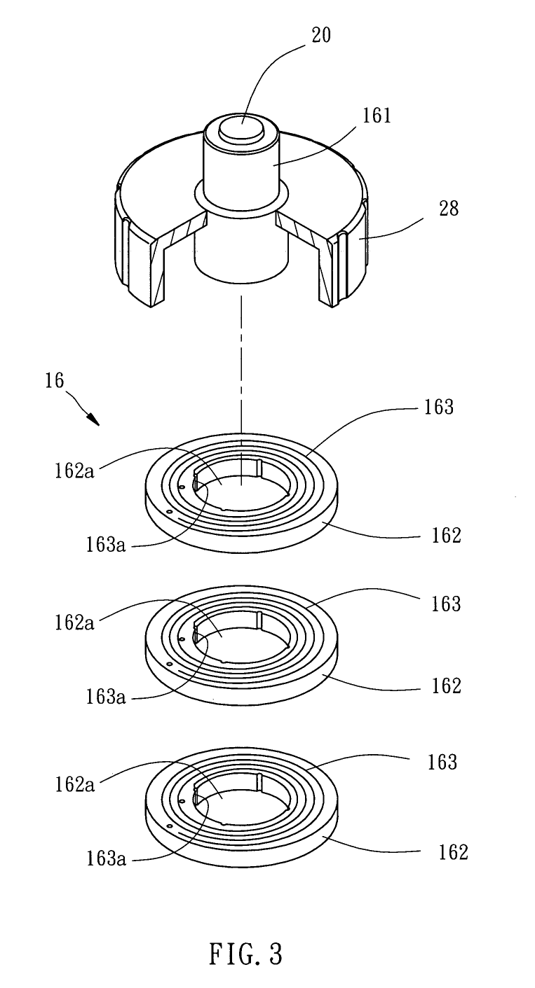

Referring to FIGS. 1-5, a pressure sensing apparatus 10 is shown installed in a wheel rim 41 carrying a tire 40. The tire pressure sensing apparatus 10 comprises a pressure sensor 12, an air valve seat 14, a transmitting antenna 16, a valve stem 18, a plunger 20, a first electrically insulating member 22, a second electrically insulating member 24, a locknut 26, and a cover 28.

The pressure sensor 12 is mounted inside the tire 40 to detect the inside pressure of the tire 40 and to output through its RF circuit output terminal (not shown) a radio frequency signal indicative of the inside pressure of the tire 40. Because the pressure sensor 12 is of the known art, no further detailed description in this regard is necessary.

The air valve seat 14 is a tube body made of electrically conducting material, having one end electrically connected to the RF circuit output terminal of the pressure sensor 12 and the other end extending out of a valve hole 41a on the wheel rim 41 and forming a free end. The air valve seat 14 has an inside air passage 141 formed through the two distal ends of the air valve seat in air communication with the inside space of the pressure sensor 12, and an outer thread 142. The outer thread 142 extends from the free end of the air valve seat 14 around the periphery thereof toward the other end near the pressure sensor 12.

The transmitting antenna 16 comprises a cap 161, three substrates 162 and three metal conducting wires 163. The cap 161 is a metal member threaded onto the outer thread 142 at the free end of the air valve seat 14, having a center air hole 161a in air communication with the air passage 141 of the air valve seat 14. The three substrates 162 are annular members arranged in a stack, each having a center coupling hole 162a respectively coupled to the cap 161. The three metal conducting wires 163 are respectively spirally mounted in the three substrates 162 around the respective center coupling hole 162a, each having an inner end 63a exposed on the periphery wall of the respective center coupling hole 162a and disposed in positive contact with the cap 161 such that the conducting wires 163 are electrically connected with the metal cap 161 for enabling the pressure signal detected by the pressure sensor 12 to be transmitted to the main unit (not shown) in the car through the air valve seat 14, the cap 161 and the conducting wires 163.

The valve stem 18 is mounted in the air passage 141 near the free end of the air valve seat 14 and axially movable in the air passage 141 by an external force to change the closed state of the air passage 141 to the opened state for allowing external air to pass through the air passage 141 and the pressure sensor 12 to the inside of the tire 40.

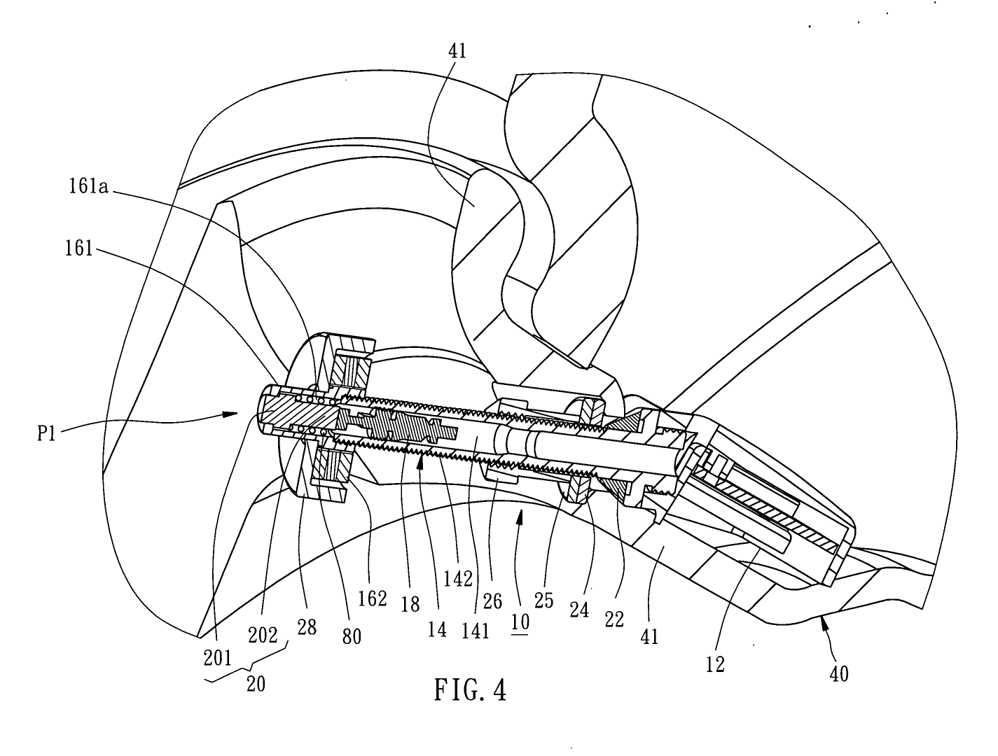

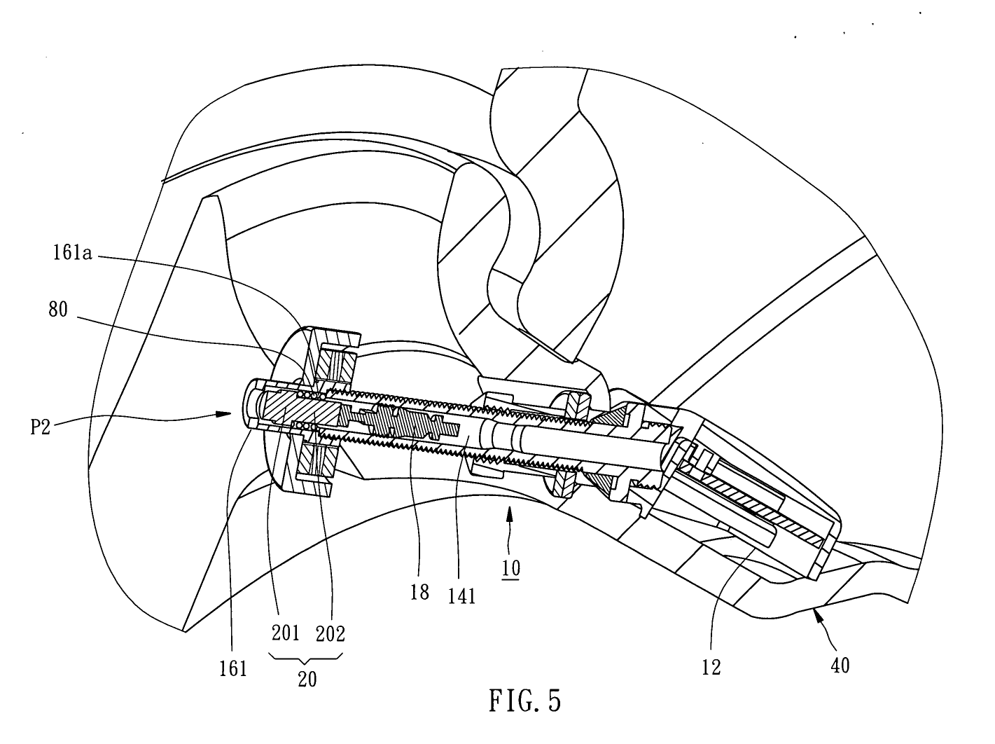

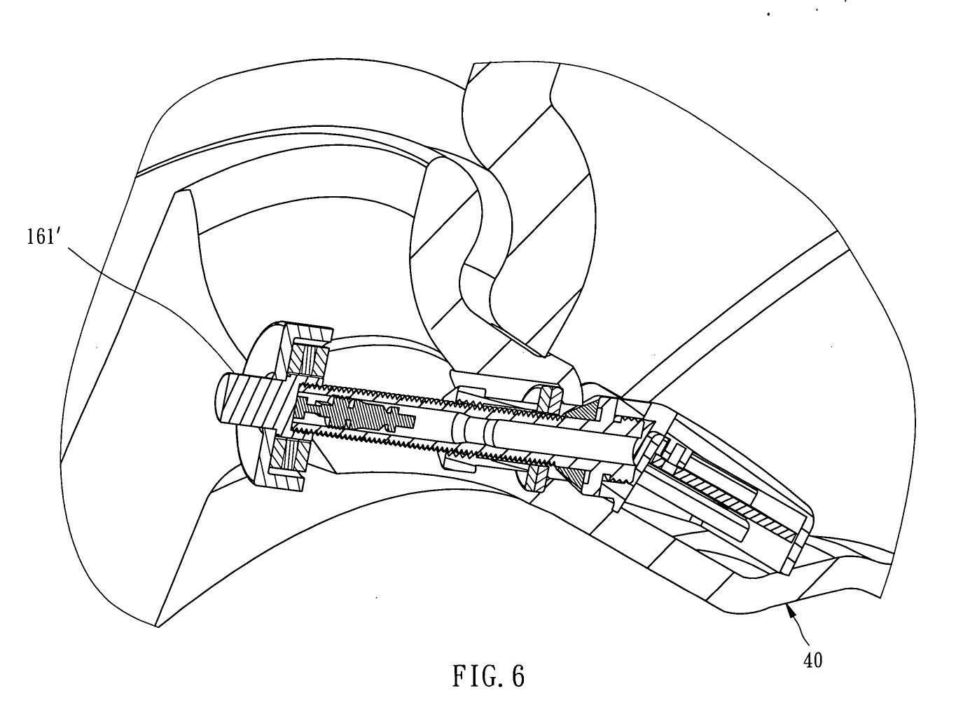

The plunger 20 is inserted through the center air hole 161a of the cap 161, having a contact portion 201 and a driving portion 202. The contact portion 201 extends out of the cap 161. The driving portion 202 is stopped against the valve stem 18. Further, a spring member 80 is sleeved onto the driving portion 202 and stopped with its two opposite ends against the bottom edge of the contact portion 201 and the free end of the air valve seat 14 to support the plunger 20 in a first position P1 (see FIG. 4) where the contact portion 201 is kept extending out of the cap 161. At this time, the plunger 20 simply contacts the valve stem 18 without moving the valve stem 18, and therefore the air passage 141 is in the closed state (see FIG. 4). Further, when the contact portion 201 of the plunger 20 is received an external force and moved inwardly from the aforesaid first position P1 to a second position P2 (see FIG. 5), the valve stem 18 is moved axially in the air passage 141 by the plunger 20 to open the air passage 141 (see FIG. 5). When the external force is released from the plunger 20, the spring member 80 immediately pushes the plunger 20 backwards from the second position P2 to the first position P1, and the valve stem 18 is returned, and therefore the air passage 141 is closed again. The aforesaid plunger 20 and spring member 80 can be treated as additional elements to enhance the applicability of the tire pressure sensing apparatus 10. However, the plunger 20 and the spring members 80 can be eliminated if desired. In this case, an end cap 161′ is used to seal the gap (see FIG. 6). After removal of the end cap 161′, the user can inflate the tire.

The first electrically insulating member 22 and the second electrically insulating member 24 are molded from rubber and respectively wrapped about the air valve seat 14 and the junction between the air valve seat 14 and the pressure sensor 12 to isolate the air valve seat 14 from the wheel rim 41 so as to prevent change of signal transmission characteristic impedance of the air valve seat 14 due to direct contact of the metal air valve seat 14 with the metal wheel rim 41. Further, the position of the second electrically insulating member 24 is adjustable by the locknut 26 on the outer thread 142, i.e., the user can rotate the locknut 26 to move the second electrically insulating member 24 toward the first electrically insulating member 22, forcing the first electrically insulating member 22 and the second electrically insulating member 24 to respectively stop against the opposite lateral walls of the wheel rim 41. Further, a pad 25 is set between the locknut 26 and the second electrically insulating member 24 to prevent deformation of the second electrically insulating member 24 when it is squeezed by the locknut 26.

Further, the cover 28 is covered on the cap 161 over the substrates 162 to protect the substrates 162 and the metal conducting wires 163 against damage. According to the present preferred embodiment, the cover 28 is molded from plastics.

By means of the aforesaid structure, the pressure sensor 12 inside the tire 40 transmits detected tire pressure signal to the air valve seat 14 when the driver is driving the car, enabling the tire pressure signal to be transmitted into the air by radio by means of the air valve seat 14 and the spiral metal conducting wires 163 on the substrates 162. By means of the aforesaid structure, the transmitting range of the radio tire pressure signal transmitted by the tire pressure sensing apparatus 10 is much greater than the conventional designs, and the main unit in the car can accurately receive the radio tire pressure signal. Therefore, the driver knows accurately the tire pressure status when driving the car, preventing a potential danger.

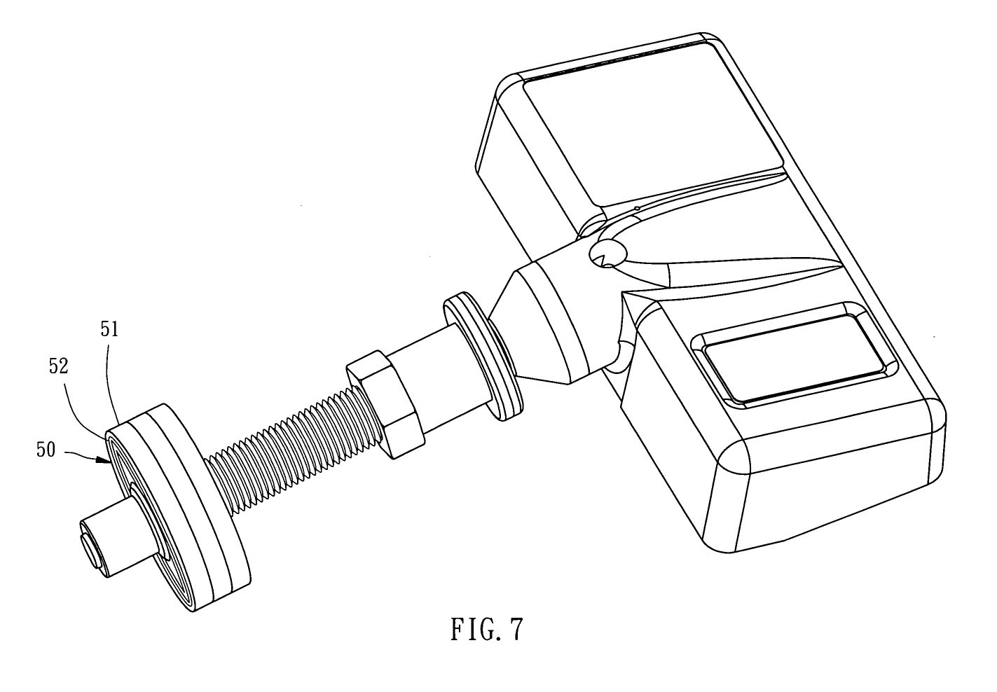

FIG. 7 shows that the aforesaid cover 28 can be eliminated to have the substrates 51 and three metal conducting wires 52 of the transmitting antenna 50 be exposed to the outside.

Examples of the tire pressure sensing apparatus have been constructed with the features of FIGS. 1-5. The tire pressure sensing apparatus functions smoothly to provide all of the features discussed earlier.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A pressure sensing apparatus comprising:
a pressure sensor for detecting tire pressure and generating a signal corresponding to the tire pressure;
an air valve seat made of an electrically conducting material and electrically connected to the pressure sensor, the air valve seat having an air passage extending through two distal ends thereof; and
a transmitting antenna having a cap made of a metal material and connected to the air valve seat, at least one substrate having an annular shape defining a center coupling hole coupled to the cap, and at least one metal conducting wire spirally mounted in the at least one substrate around the center coupling hole, the at least one metal conducting wire each having an inner end exposed to a periphery wall of the center coupling hole of the at least one substrate and electrically connected to the cap.

2. The pressure sensing apparatus as claimed in claim 1, further comprising a cover made of plastic and covered on the cap and shielding the at least one substrate.

3. The pressure sensing apparatus as claimed in claim 1, wherein the cap is fastened to one end of the air valve seat and provided with a center air hole in air communication with the air passage; wherein the pressure sensing apparatus further comprises a plunger inserted through the center air hole of the cap and movable relative to the cap between a first position and a second position, and a valve stem mounted in the air passage and movable with the plunger between said first position where said valve stem blocks the air passage and said second position where said valve stem opens said air passage.
